(19) United States
(12) Patent Application Publication
(10) Pub. No.: US 2026/0287876 A1
(43) Pub. Date: Sep. 24, 2026

(54) FIELD-OF-VIEW LEVELING METHOD FOR ULTRA-LARGE FIELD-OF-VIEW MICROSCOPE DRIVEN BY ELECTRIC CYLINDER

(71) Applicant: ZHEJIANG HEHU TECHNOLOGY CO., LTD., HANGZHOU (CN)

(72) Inventor: YI YANG, HANGZHOU (CN)

(21) Appl. No.: 19/358,856

(22) Filed: Oct. 15, 2025

(30) Foreign Application Priority Data
Mar. 21, 2025 (CN) 202510341501.4

(51) Int. Cl. G02B 21/36; G02B 21/26

(52) U.S. Cl. CPC G02B 21/36; G02B 21/26

(57) ABSTRACT

A field-of-view leveling method for an ultra-large field-of-view microscope including an electric cylinder, a lens and a microscope stage, is provided. The microscope stage includes an X-axis and a Y-axis for controlling deflection of the stage around the X- and Y-axes. The method includes: S1: performing microscopic image acquisition on a to-be-photographed sample at an initial angle through the lens to obtain an initial microscopic image; S2: performing microscopic image acquisition at several angles within a set deflection angle range on the X-axis to obtain several deflected microscopic images; S3: after each angle deflection, performing microscopic image registration and cropping on the deflected microscopic image according to the initial microscopic image; S4: calculating clarity of the microscopic images at the initial angle and several angles; and S5: with the X-axis optimal angle used as a reference, repeating S2 to S4 to adjust and obtain the Y-axis optimal angle.

### CROSS REFERENCE TO RELATED APPLICATIONS

The present disclosure claims the priority to the Chinese patent application with the filing No. 202510341501.4, entitled “FIELD-OF-VIEW LEVELING METHOD FOR ULTRA-LARGE FIELD-OF-VIEW MICROSCOPE DRIVEN BY ELECTRIC CYLINDER” and filed on Mar. 21, 2025 with the Chinese Patent Office, the contents of which are incorporated herein by reference in their entirety.

### TECHNICAL FIELD

The present disclosure relates to the field of microscopic imaging technique, and particularly to a field-of-view leveling method for an ultra-large field-of-view microscope driven by an electric cylinder.

### BACKGROUND ART

In modern scientific research and technique applications, large field-of-view microscopes have gained widespread popularity due to their unique advantages. These microscopes are primarily used for macro-to-micro structural analysis in fields such as materials science, life sciences, and medical research. Compared with traditional microscopes, large field-of-view microscopes offer a larger field of view without sacrificing resolution, enabling the observer to acquire information of a sample with larger area at once, which is of great significance to understand complex biological tissue structures or material surface features. In addition, it also has the characteristic of high throughput, enabling rapid scanning of the region of the sample with large area, and significantly improving experimental efficiency and data acquisition speed, which is particularly valuable for applications that require a large number of sample tests.

Field-of-view leveling is a crucial step when observing with a large field-of-view microscope. Due to the limited working distance of the microscope, when the magnification increases, the depth of field decreases accordingly, which means that only a very thin layer of the sample is in focus. Therefore, to ensure that all regions of interest within the entire field of view are clearly imaged, the sample must be precisely leveled. Good leveling not only improves image quality and reduces edge blur phenomenon, but also prevents the loss of important information due to localized defocus, thereby ensuring data accuracy and reliability. Especially in quantitative analysis, such as particle size measurement or cell counting, the accuracy of field-of-view leveling is directly related to the validity of the final results.

Traditional manual leveling methods, while adequate in some simple situations, have numerous limitations.

First, manual operation is time-consuming, especially when dealing with complex or large-size samples, repeated adjustments are needed until satisfaction is achieved. Second, human eye judgment is easily affected by subjective factors, and different operators may obtain different leveling results, resulting in poor repeatability. Third, operators are prone to fatigue under long-term high-intensity work, which in turn affects leveling accuracy.

Therefore, improvements are needed, and a field-of-view leveling method for an ultra-large field-of-view microscope driven by an electric cylinder is proposed.

### SUMMARY

The purpose of the present disclosure is to provide a field-of-view leveling method for an ultra-large field-of-view microscope driven by an electric cylinder, so as to overcome the deficiencies in the prior art.

To achieve the above purpose, the present disclosure provides the following technical solutions.

The present disclosure discloses a field-of-view leveling method for an ultra-large field-of-view microscope driven by an electric cylinder, including the electric cylinder, a lens, and a microscope stage, where the microscope stage includes an X-axis and a Y-axis for controlling the deflection of the stage around the X-axis and the Y-axis, and a to-be-photographed sample is provided on the microscope stage, the including the following steps:
S1: performing microscopic image acquisition on the to-be-photographed sample at the initial angle through the lens to acquire an initial microscopic image;
S2: starting from the initial angle, performing microscopic image acquisition from the X-axis at several angles within a set deflection angle range to acquire several deflected microscopic images;
S3: after each angle deflection, performing microscopic image registration and cropping on the deflected microscopic image according to the initial microscopic image, to ensure the accuracy of subsequent images;
S4: calculating and obtaining the clarity of the microscopic images at the initial angle and the several angles; and
S5: with the X-axis optimal angle used as a reference, repeating steps S2 to S4 to determine the Y-axis optimal angle, thereby completing the XY dual-axis global leveling.

Preferably, the S2 includes performing acquisition from any one of the X-axis and the Y-axis, and when returning to S2 in S5, the acquisition is performed from the other of the X-axis and the Y-axis.

Preferably, the S1 includes the following contents: acquiring a region of interest of the to-be-photographed sample, and acquiring a microscopic image at the current angle, with the current position taken as the initial angle.

Preferably, the S2 includes the following sub-steps:
S21: acquiring several acquisition angles within a preset deflection angle range according to the initial angle;
S22: performing microscopic image acquisition at the several acquisition angles; and
S23: acquiring an image sequence according to microscopic images at the several angles.

Preferably, the S3 includes the following content: since the to-be-photographed sample in the field of view moves during the angle deflection process, each image needs to be translated and registered according to the initial angle as a reference, and the registered images are cropped to retain the common region.

Preferably, the translation and registration in the S3 includes the following content: performing registration on the microscopic image by using the matchTemplate function in OpenCV.

Preferably, the S4 includes the following content: for the cropped initial microscopic image and the deflected microscopic images in S3, the total variation is calculated and obtained respectively by the height, width, row and column indices of each of the images; and under the premise of having the same foreground target, the larger total variation demonstrates the higher clarity thereof.

Preferably, S5 includes the following content: according to the calculation result of S4, extracting the deflected microscopic image corresponding to the clearest image, and deflecting the microscope stage to this angle; and then returning to S2, repeating the contents of S2 to S4 on the Y-axis to obtain the clearest angles on the X-axis and Y-axis, thus achieving global field-of-view leveling in the XY dual dimensions.

The present disclosure further discloses a field-of-view leveling apparatus for an ultra-large field-of-view microscope driven by an electric cylinder, including a memory and one or more processors, where the memory stores executable code, and the one or more processors are used to implement the above-mentioned field-of-view leveling method for an ultra-large field-of-view microscope driven by an electric cylinder when executing the executable code.

The present disclosure further discloses a computer-readable storage medium having a program stored thereon. When the program is executed by the processor, the field-of-view leveling method for an ultra-large field-of-view microscope driven by an electric cylinder is implemented.

Beneficial effects of the present disclosure:
(1) the field of view of a large field-of-view microscope is very large, and manual focusing is difficult to ensure that the ideal focal plane is obtained in the entire field of view; the present disclosure uses an automated electric cylinder leveling system to accurately level the entire large field of view, ensuring the consistency of imaging quality from the center to the edge;
(2) in biological research, it is often necessary to perform imaging analysis on large areas of tissue sections or cell samples, which needs to be completed under a large field of view; the use of automated leveling in the present disclosure may greatly improve the efficiency of this process, achieve true high-throughput, unattended processing, and speed up the analysis process of large field-of-view samples; and
(3) for large field-of-view imaging, manual leveling is a very arduous task, and the operator is prone to visual fatigue, thereby increasing the risk of mis-operation; however, the use of automated leveling in the present disclosure may reduce this burden and improve the reliability of experimental data.

The features and advantages of the present disclosure will be described in detail through embodiments with reference to the drawings.

### BRIEF DESCRIPTION OF DRAWINGS

FIG. 1 is a flowchart of the steps of a field-of-view leveling method for an ultra-large field-of-view microscopes driven by an electric cylinder according to the present disclosure;

FIG. 2 is a schematic diagram of a single-dimensional leveling process of the present disclosure;

FIG. 3 is a schematic diagram of the present disclosure before and after registration and cropping; and

FIG. 4 is a schematic diagram of the apparatus of the present disclosure.

### DETAILED DESCRIPTION OF EMBODIMENTS

To make the purposes, technical solutions, and advantages of the present disclosure more clearly understood, the present disclosure will be further described in detail below with reference to the drawings and examples. However, it should be understood that the specific embodiments described herein are merely illustrative of the present disclosure and are not intended to limit the scope of the present disclosure. In addition, in the following description, descriptions of well-known structures and technologies are omitted to avoid unnecessary confusion of the present disclosure.

In the present disclosure, by integrating advanced sensor technology and computer vision algorithms, the automated system achieves rapid and precise leveling. This not only significantly shortens setup time and improves work efficiency, but also significantly reduces human error and ensures optimal leveling every time. Therefore, automated leveling is not only an inevitable trend in technological advancement but also a key to improving scientific research quality and production efficiency.

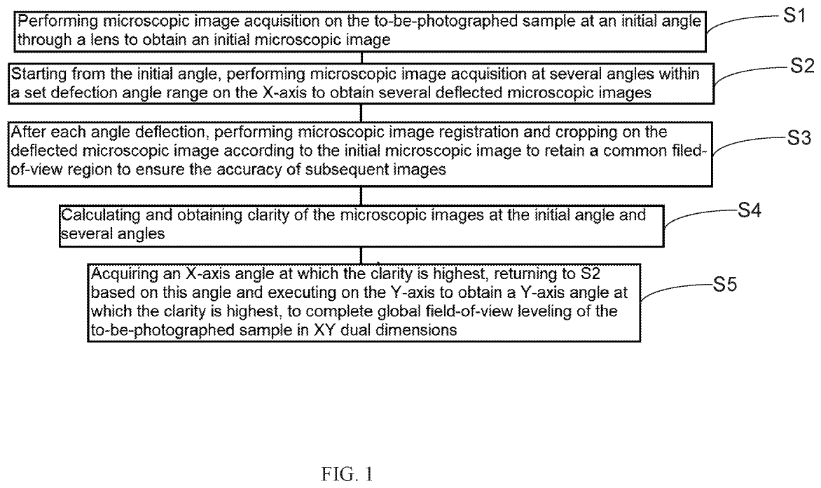

Referring to FIG. 1, an embodiment of the present disclosure provides a field-of-view leveling method for an ultra-large field-of-view microscopes driven by an electric cylinder, which uses multiple real-time photographed images of the to-be-photographed sample as data sources and finds the globally clearest image through the optimal search idea, thereby achieving the purpose of leveling.

The embodiments of the present disclosure include the following parts.

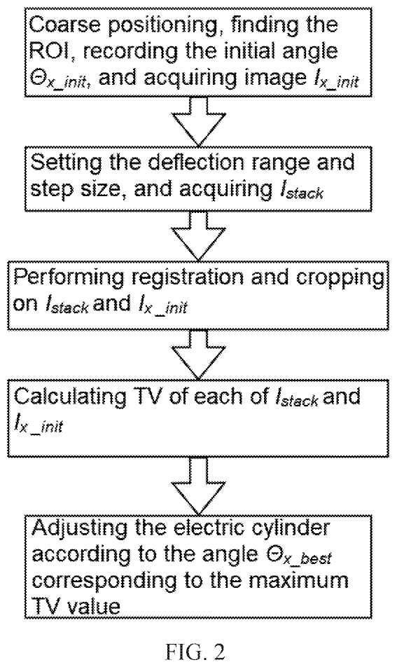

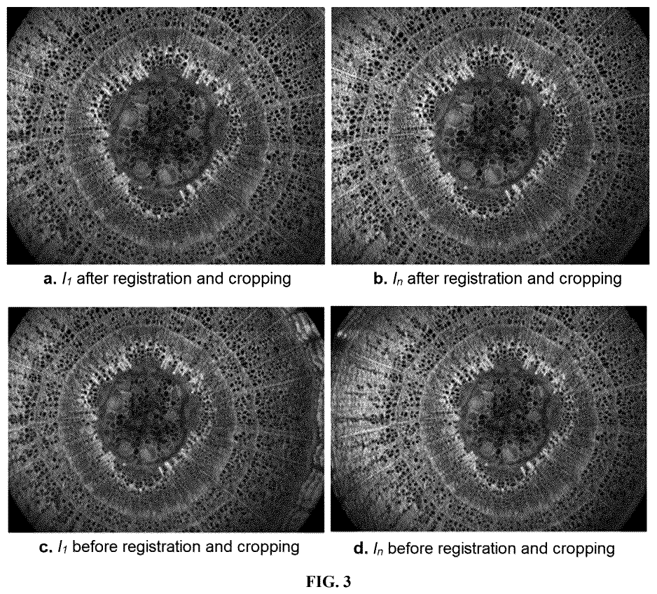

The cylinder-driven microscope stage may be simplified to perform deflection around the X-axis and deflection around the Y-axis. The following steps take the X-axis as an example. The schematic diagram of the single-dimensional leveling process is as shown in FIG. 2.
S1. Microscopic image acquisition at the initial point: finding the ROI (region of interest) of the to-be-photographed sample, and with the current angle of the electric cylinder driven platform in the x-direction used as the initial angle θ_{x_nit}, acquiring the microscopic image I_{x_init} at this angle;
S2. multi-angle microscopic image acquisition: sending instructions to the electric cylinder driver via a program, to perform multi-angle microscopic image acquisition with θ_{x_init} as the initial angle, within the set deflection angle range (−θₓ, θₓ), and at the preset angle step size Øₓ, to obtain an image sequence I_{stack}=[I₁, I₂, I₃, . . . , Iₙ], where n=(2θₓ/Øₓ+1)−1. The subtraction of 1 (−1) is because the microscopic image at the initial angle θ_{x_init} has already been acquired in S1 and does not need to be acquired again here. A configuration with an initial angle θ_{x_init} of 1.5°, a set deflection angle range (−θₓ, θₓ) of (−1° to 1°), and an angle step size Øₓ of 0.2° is taken as an example. In this case, in the resulting image sequence I_{stack}=[I₁, I₂, I₃, . . . , Iₙ], n=(2*1/0.2+1)−1=10;
S3. multi-angle microscopic image registration, where since the to-be-photographed samples within the field of view moves slightly during the angular deflection process, each image in the image sequence I_{stack} needs to be subjected to image translation and registration by using the initial microscopic image I_{x_init} as a reference, to ensure that subsequent calculations are performed within the common field of view of I_{stack} and I_{x_init}, the matchTemplate function in OpenCV may be used for registration, all the registered images are cropped, retaining only the common region for subsequent calculations. The schematic diagrams of the effects before and after registration and cropping are as shown in FIG. 3.

In a feasible embodiment, after completing the registration and cropping, the images are subjected to uniform resolution processing, thereby reducing the time and resources required for processing in subsequent calculation procedures.
S4. Global clarity calculation: for the cropped I_{stack} and I_{x_init}, calculating the TVs (total variations) of I₁, I₂, I₃, . . . , Iₙ and I_{x_init} respectively. Under the premise of having the same foreground target, the larger TV value demonstrates the more dramatic pixel changes between adjacent pixels. From a visual perspective, the more obvious the distinction between the tissues is, the clearer it is. Therefore, the TV value may be used as the basis for its clarity. The TV calculation process may be expressed as formula (1):

$$TV = {\sum }_{j = 1}^{w} {\sum }_{i = 1}^{h - 1} {I}_{i j} - {I}_{i + 1 , j} + {\sum }_{j = 1}^{w - 1} {\sum }_{i = 1}^{h} {I}_{i , j} - {I}_{i , j + 1} \qquad ( 1 )$$

where h and w indicate the pixel height and width of the cropped image, respectively; and i and j indicate the row and column indices of the image, respectively;
S5. feedback of calculation results: after obtaining the TV calculation result of S4, obtaining the corresponding deflection angle θ_{x_best} according to the position index with the largest TV value, feeding the deflection angle value back to the electric cylinder driver to make it drive the stage to deflect to the specified angle θ_{x_best}, and photographing the microscopic image corresponding to this angle as the initial image Iv, and then, performing the above steps S2 to S4 on the Y-axis and finally, feeding the Y-axis θ_{y_best} back to the electric cylinder driver to make it deflect to the specified angle to complete the global field-of-view leveling in the XY dual dimensions.

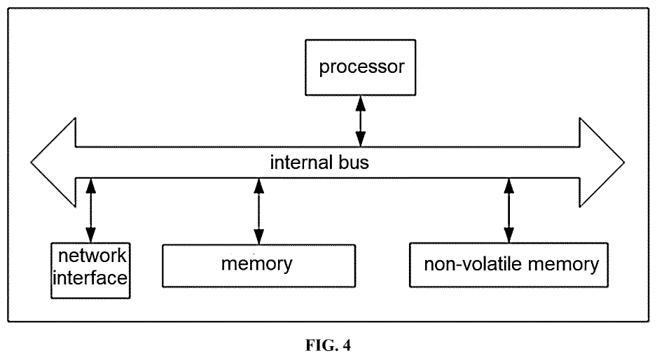

The embodiment of the field-of-view leveling apparatus for an ultra-large field-of-view microscope driven by an electric cylinder of the present disclosure may be applied to any device with data processing capability, and the any device with data processing capability may be a device or apparatus such as a computer. The apparatus embodiment may be implemented by software, or by hardware or a combination of software and hardware. Taking software implementation as an example, as an apparatus in a logical sense, it is formed by the processor of any device with data processing capability where it is located reading the corresponding computer program instructions in the non-volatile memory into the memory for running. From the hardware level, as shown in FIG. 4, it is a hardware structure diagram of any device with data processing capability where the field-of-view leveling apparatus for an ultra-large field-of-view microscopes driven by an electric cylinder of the present disclosure is located. In addition to the processor, memory, network interface, and non-volatile memory as shown in FIG. 4, any device with data processing capability where the apparatus in the embodiment is located may also include other hardware according to the actual function of the any device with data processing capability, which may not be repeated here. The implementation process of the functions and effects of each unit in the above-mentioned apparatus is specifically detailed in the implementation process of the corresponding steps in the above-mentioned method, which may not be repeated here.

For the apparatus embodiments, since they basically correspond to the method embodiments, the relevant parts may be referred to the description of the part of the method embodiments. The apparatus embodiments described above are merely illustrative, where the units described as separate components may or may not be physically separated, and the components shown as units may or may not be physical units, that is, they may be located in one place or distributed across multiple network units. Some or all of the modules may be selected according to actual needs to achieve the purpose of the present disclosure. A person of ordinary skill in the art may understand and implement the present disclosure without inventive work.

An embodiment of the present disclosure further provides a computer-readable storage medium having a program stored thereon. When the program is executed by a processor, the field-of-view leveling apparatus of an ultra-large field-of-view microscope driven by an electric cylinder in the above embodiment is implemented.

The computer-readable storage medium may be an internal storage unit of any device with data processing capability according to any of the aforementioned embodiments, such as a hard disk or memory. The computer-readable storage medium may also be an external storage device of any device with data processing capability, such as a plug-in hard disk, a Smart Media Card (SMC), an SD card, a flash memory card, etc., equipped on the device. Further, the computer-readable storage medium may include both an internal storage unit and an external storage device of any device with data processing capability. The computer-readable storage medium is used to store the computer program and other programs and data required by any device with data processing capability, and may also be used to temporarily store data that has been output or is to be output.

The above description is only a preferred embodiment of the present disclosure and is not intended to limit the present disclosure. Any modifications, equivalent substitutions or improvements made within the spirit and principles of the present disclosure should be included in the scope of protection of the present disclosure.

1. A field-of-view leveling method for an ultra-large field-of-view microscope driven by an electric cylinder, the ultra-large field-of-view microscope comprising the electric cylinder, a lens, and a microscope stage; wherein the microscope stage comprises an X-axis and a Y-axis allowing the electric cylinder to control deflection of the stage around the X-axis and the Y-axis wherein a to-be-photographed sample is disposed on the microscope stage, the field-of-view leveling method comprising:
S1: performing microscopic image acquisition on the to-be-photographed sample at an initial angle through the lens to obtain an initial microscopic image;
S2: sending an instruction to the electric cylinder through a program, to cause the electric cylinder, starting from the initial angle, to perform microscopic image acquisition at a plurality of angles around the X-axis, within a set deflection angle range and at a preset angular step, to obtain a plurality of deflected microscopic images;
S3: performing, after deflection at each angular step, microscopic image registration and cropping on the deflected microscopic image according to the initial microscopic image, to retain a common field-of-view region to ensure an accuracy of subsequent images;
S4: calculating and obtaining clarity of the microscopic images at the initial angle and the plurality of angles, and calculating total variations (TVs) of the plurality of deflected microscopic images and the initial microscopic image; and
S5: obtaining, from a position index corresponding to a largest TV value after obtaining a calculation result of the TVs in S4, an X-axis deflection angle at which the clarity is highest, feeding the X-axis deflection angle back to an electric cylinder driver to cause the electric cylinder driver to drive the stage to deflect to a specified angle, photographing a microscopic image corresponding to the angle as an initial image, then performing the S2 to S4 operations around the Y-axis, and finally feeding a Y-axis deflection angle back to the electric cylinder driver to cause the electric cylinder driver to drive the stage to deflect to a specified angle to complete global field-of-view leveling of the sample in X and Y dual dimensions.

2. The field-of-view leveling method according to claim 1, wherein the global field-of-view leveling in the S5 is achieved through iterative optimization, and a leveling order of the X-axis and the Y-axis is interchangeable; and the S2 comprises performing acquisition on any one of the X-axis and the Y-axis, and when returning to the S2 in the S5, the acquisition is performed on another of the X-axis and the Y-axis.

3. The field-of-view leveling method according to claim 1, wherein the S1 comprises: acquiring a region of interest of the to-be-photographed sample, and with a current position used as the initial angle, acquiring a microscopic image at a current angle.

4. The field-of-view leveling method according to claim 1, wherein the S2 comprises:
S21: acquiring a plurality of acquisition angles within the preset deflection angle range according to the initial angle;
S22: performing microscopic image acquisition at the plurality of acquisition angles; and
S23: acquiring an image sequence according to the microscopic images at the plurality of angles.

5. The field-of-view leveling method according to claim 1, wherein the S3 comprises: since the to-be-photographed sample in a field of view moves during an angle deflection process, subjecting each image to translation and registration taking the initial angle as a reference, and cropping the registered images to retain a common region.

6. The field-of-view leveling method according to claim 5, wherein the translation and registration in the S3 comprises: registering the microscopic images by using a match Template function in a template matching algorithm.

7. The field-of-view leveling method according to claim 1, wherein the S4 comprises: for the initial microscopic image and the deflected microscopic images cropped in the S3, calculating a total variation by a height, width, row and column indexes of each of the images respectively; wherein under a premise of having a same foreground target, a larger total variation demonstrates higher clarity.

8. The field-of-view leveling method according to claim 1, wherein the S5 comprises: according to a calculation result of the S4, extracting a deflected microscopic image corresponding to a clearest image, and deflecting the microscope stage to the angle; and then returning to the S2, and repeating the S2 to S4 around the Y-axis to obtain clearest angles on the X-axis and the Y-axis, thus achieving global field-of-view leveling in the XY dual dimensions.

9. A field-of-view leveling apparatus for an ultra-large field-of-view microscopes driven by an electric cylinder, comprising a memory and one or more processors, wherein the memory stores code executable by the one or more processors, which, when executing the executable code, cause the field-of-view leveling method according to claim 1 to be performed.

10. A non-transitory computer-readable storage medium, storing a program thereon, the program being executable by a processor, wherein the processor, when executing the program, causes the field-of-view leveling method for an ultra-large field-of-view microscope driven by an electric cylinder according to claim 1 is to be performed.
